(19) United States
(12) Patent Application Publication
(10) Pub. No.: US 2013/0277422 A1
(43) Pub. Date: Oct. 24, 2013

(54) SYSTEM AND METHOD FOR REQUESTING AND DELIVERING TARGETED INFORMATION

(71) Applicant: ABB INC., Cary, NC (US)

(72) Inventor: Hans Weinberg, Cary, NC (US)

(73) Assignee: ABB INC., Cary, NC (US)

(21) Appl. No.: 13/842,266

(22) Filed: Mar. 15, 2013

Related U.S. Application Data
(60) Provisional application No. 61/636,682, filed on Apr. 22, 2012.

(51) Int. Cl. G06Q 30/00

(52) U.S. Cl. CPC G06Q 30/016
USPC 235/375; 701/468

(57) ABSTRACT

A system and method for delivering targeted information to a user is provided. The user initiates a request for information by capturing or scanning a bar code associated with an object. The bar code is decoded and the decoded information is presented to the user. The decoded information and GPS coordinates of the user's scanning device is used to directly route the user to detailed information about the object that was scanned or the appropriate service department for servicing the object. The detailed information about the object includes but is not limited to product and system specifications, technical manuals and CAD drawings. A history of product scans is stored on the user's device and available for upload to the cloud. A portal is provided for accessing product scans and installed base information stored on the cloud.

### FIELD OF INVENTION

The present application is directed to a system and method for delivering targeted information about products and services in response to a request.

### BACKGROUND

Customers purchase products from vendors that require service throughout the operational life of the products. Likewise, customers install enterprise computing systems that require support. When a customer requires service or has questions on a particular product or installation, the customer may look to a search engine to locate parts, software updates, and answers to common questions. Alternatively, the customer may directly navigate to the purveyor or supplying organization website to peruse information. The customer may also use contact information the customer has acquired in the past, such as from a database of contacts or a business card. However, these information sources are not directed to the customer's specific requirements and in some cases, may be out of date. Accordingly, there is a need in the art for providing targeted information to a customer regarding products and services supplied by an organization.

### SUMMARY

A system and method for delivering targeted information to a user is initiated with the bar code scan of an object by a user. The captured bar code is decoded and the decoded information is presented to the user on the scanning device. The user is presented with several options following the bar code scan including but not limited to accessing detailed information about the product or service, directly linking the user to the appropriate service department via phone, text message, or e-mail, sending the scanned information to anyone via text message or e-mail, storing a history of scanned products and accessing installed base information.

The GPS coordinates of the scanning device are also captured and are used to map the installed base of a user's installed and in-service products. The GPS coordinates of a user's scanned products are stored in the history of a custom application utilizing a particular supplying organization's data. Further, the GPS coordinates of the scanning device are used to directly route a user to the appropriate service department for the city, state, and country associated with the determined GPS coordinates.

### BRIEF DESCRIPTION OF THE DRAWINGS

In the accompanying drawings, structural embodiments are illustrated that, together with the detailed description provided below, describe exemplary embodiments of a system and method for delivering targeted information to a user. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1a is a flow chart describing the steps for delivering targeted information to a user embodied in accordance with the present invention;

FIG. 1b is a continuation of the flow chart of FIG. 1a;

FIG. 2 shows an exemplary product bearing an exemplary bar code;

FIG. 3a shows a product information screen of a custom mobile application having selection options for the exemplary product of FIG. 2;

FIG. 3b shows a list of selection options available to the user for the custom mobile application installed on the device;

FIG. 3c shows a list of contact selection options for the service department of the organization supplying or servicing the product of interest;

FIG. 3d shows a screen shot of an e-mail with pre-populated product information generated by the custom mobile application as a result of capturing and decoding the bar code of FIG. 2;

FIG. 3e shows a screen shot of a SMS text message with pre-populated product information generated by the custom mobile application as a result of capturing and decoding the bar code of FIG. 2;

FIG. 3f is a screen shot of an exemplary product details screen for the product of interest;

FIG. 3g is a screen shot of an exemplary product documents screen for the product of interest;

FIG. 3h is a screen shot of a map showing the location of the product of interest and the relation to the location of the user;

FIG. 3i is a screen shot of a product images page for the product of interest;

FIG. 3j is a screen shot of a product notes pages for the product of interest;

FIG. 3k is a screen shot of a pre-populated request for contact based on a scanned bar code of the product of interest;

FIG. 4 is a flow chart that describes functionality of a pro tier application that utilizes the data captured by the custom mobile application;

FIG. 5 is a flow chart that describes functionality of an enterprise tier application that utilizes the data captured by the custom mobile application;

FIG. 6 is a screen shot of the installed base application tracking the location and characteristics of installed units; and

FIG. 7 shows the various systems, products, devices, and databases that store information in a repository on a cloud computing platform.

### DETAILED DESCRIPTION

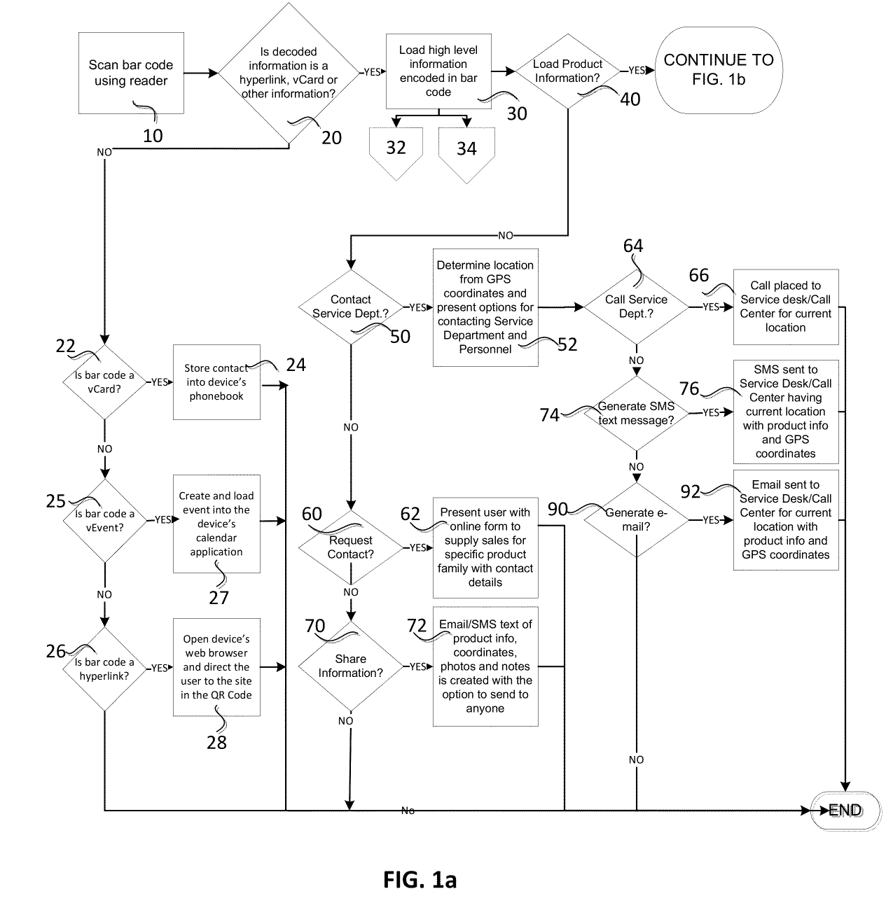

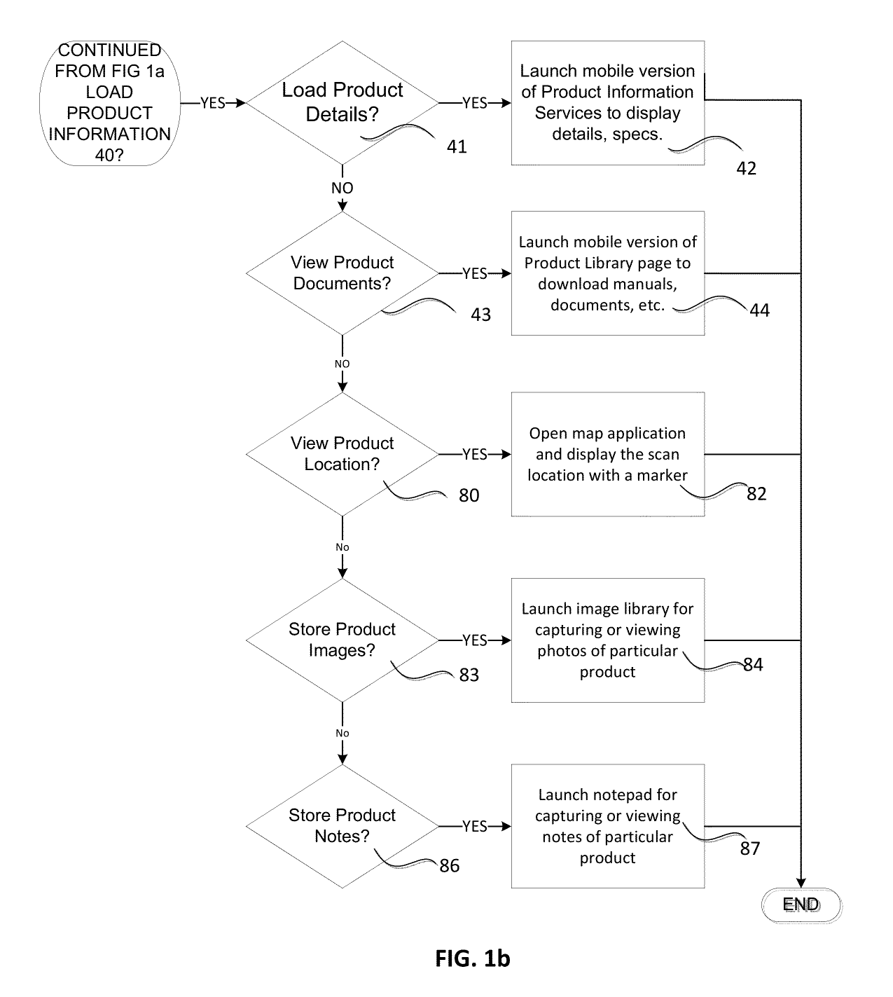

A flow chart describing the steps in a method for delivering targeted information to a user is shown in FIGS. 1a and 1b. At step 10, a barcode that is affixed, imprinted, engraved, embedded or otherwise associated with or attached to an object is captured using a barcode reader. The bar code reader also decodes the captured image. The object bearing the bar code may be a product, system, label, hard copy document, magazine, billboard, computer screen, television screen, or security camera, as non-limiting examples.

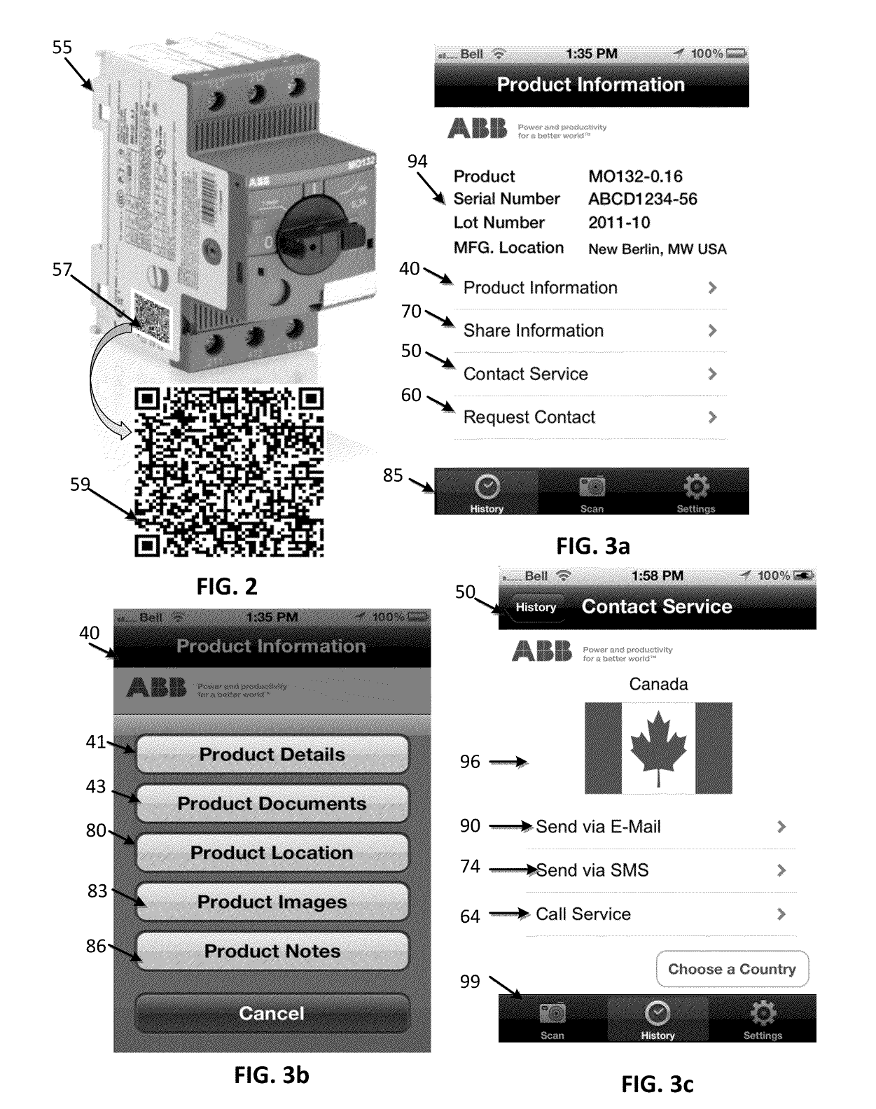

The bar code is a 1D, 2D, or 3D barcode. In one embodiment, the barcode is a “qr code,” ie. a quick response code, as depicted for an exemplary product in FIG. 2. It should be understood that any type of barcode, including but not limited to universal product codes (UPC), PostNet, EAN-13 codes, and holograms, may be used to carry out the invention.

Alternatively, it should be understood that a radio-frequency identification (RFID) tag may be embedded, implanted or otherwise attached to the object in lieu of a bar code. In the RFID tag embodiment, a standard or custom RFID reader is used to send a signal to the RFID tag and interpret or otherwise read the response that is received.

The bar code reader is either a custom or standard bar code scanner. The bar code reader captures the pattern of spaced bars or image that is affixed, attached or otherwise associated to the object. A custom bar code scanner implemented for use with an organization's specific data is the preferred method of conveying targeted data to a user. However, a generic bar code reader has the capability to decode the qr code image to provide object details and navigate the user to a hyperlink embedded therein.

The bar code reader may utilize the camera of a smart phone, tablet personal computer, or another type of personal computer. Alternatively, the bar code reader is embodied as a handheld wireless barcode scanner, Bluetooth®-enabled bar code scanner or a tethered bar code scanner. A person having ordinary skill in the art will appreciate that various other methods and devices for capturing, scanning, and decoding a barcode are contemplated, and that the invention is not limited to the examples set forth herein.

The system of the present application has a memory that stores computer executable instructions and a processor that executes the computer executable instructions. The computer executable instructions cause the processor to implement the following steps: a) a determination of a requesting user's global positioning system coordinates; b) a mapping of said coordinates to a set of service communication options; c) a presentation of said service communication options based on said mapped coordinates; d) transmission of a selected service communication to a service department, said transmission automatically populated with product information; and e) initiation of said service request by the service system that receives the request. In one embodiment, a response from said service department regarding the initiation of the service request is sent to the requesting device 480.

Additionally, an embodiment of the present application features a device 480 that has a computer readable storage medium encoded with one or more computer executable instructions. The one or more computer readable instructions are executed by a processor of the computing system and cause the processor to implement the aforementioned steps a) through e).

With reference now to step 20 of FIG. 1a, following the scanning of the bar code using a customized or generic barcode reader as described above, the reader decodes the bar code. If the bar code represents an electronic business card, otherwise known as a vCard, the contact information on the vCard is stored in the smart phone, tablet, or personal computer's contact list at step 24. Further, at step 25, if the bar code represents and electronic event, otherwise known as a vEvent, the location, date, start time, end time, and duration of the event are stored and/or a calendar entry is created 27 in the calendar of the requesting device 480. In one embodiment, the calendar entry creates a series of sub-entries for individual meetings or sub-events corresponding to the main calendar entry. Moving to step 26, if the bar code represents a hyperlink, the web browser of the device 480 is opened and the user is directed to the URL embedded in the bar code at step 28.

If the bar code is scanned using a bar code reader that is customized for a purveyor or particular organization supplying products, systems and/or services, the decoded information routes the user to an organization-specific web portal page containing information about the specific object scanned. The user is taken to a webpage and/or portal page showing specifications for the object as well as technical manuals, service manuals, and engineering drawings. Further, options are presented that allow the user to request more information regarding a product or to be contacted by service personnel from the organization, such as customer service, field service, or another type of support or technical service.

Moving to step 30 of FIG. 1a, a customized bar code reader enabled for use with the data of a particular organization presents the user with the option of using pro tier at step 32 or enterprise tier at step 34, to be discussed in further detail below. Generally, the pro tier 32 is a subscription service providing flexible reporting and monitoring using data stored on the cloud 400 to an individual user. The enterprise tier 34 is used by the information technology, customer service and technical personnel of an organization to support their customer base.

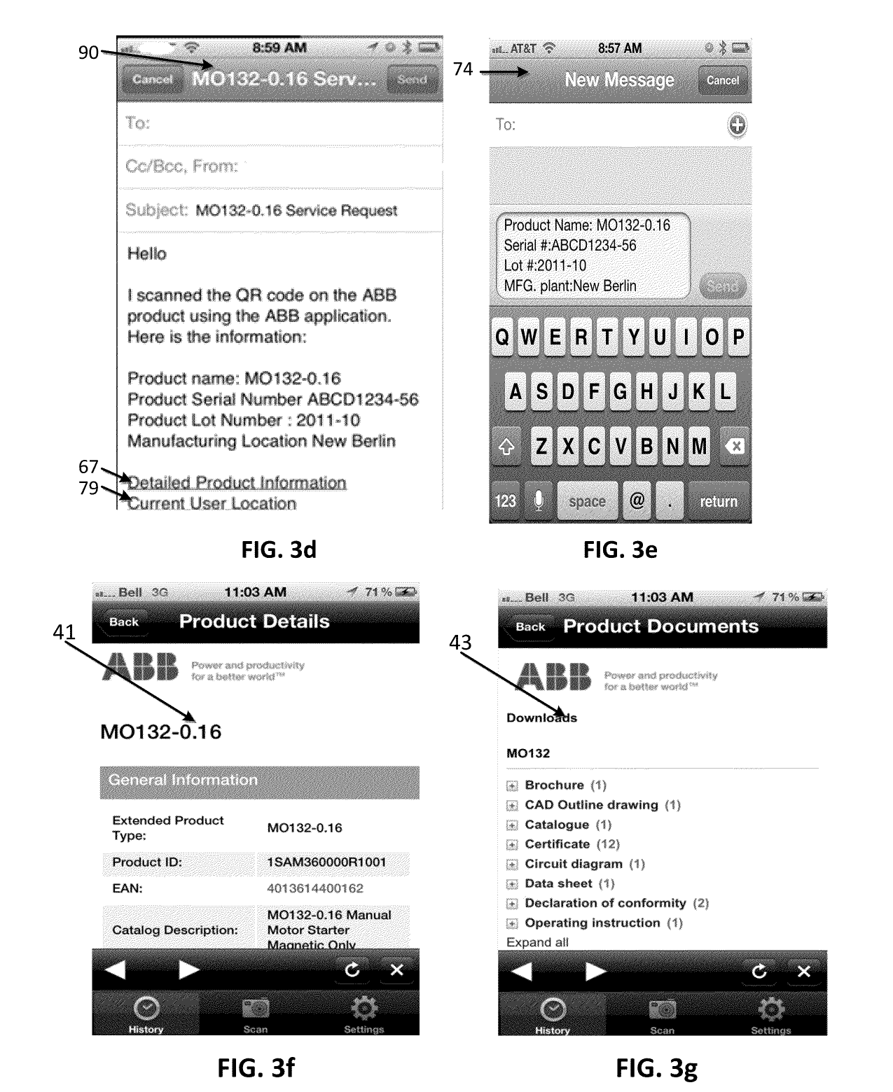

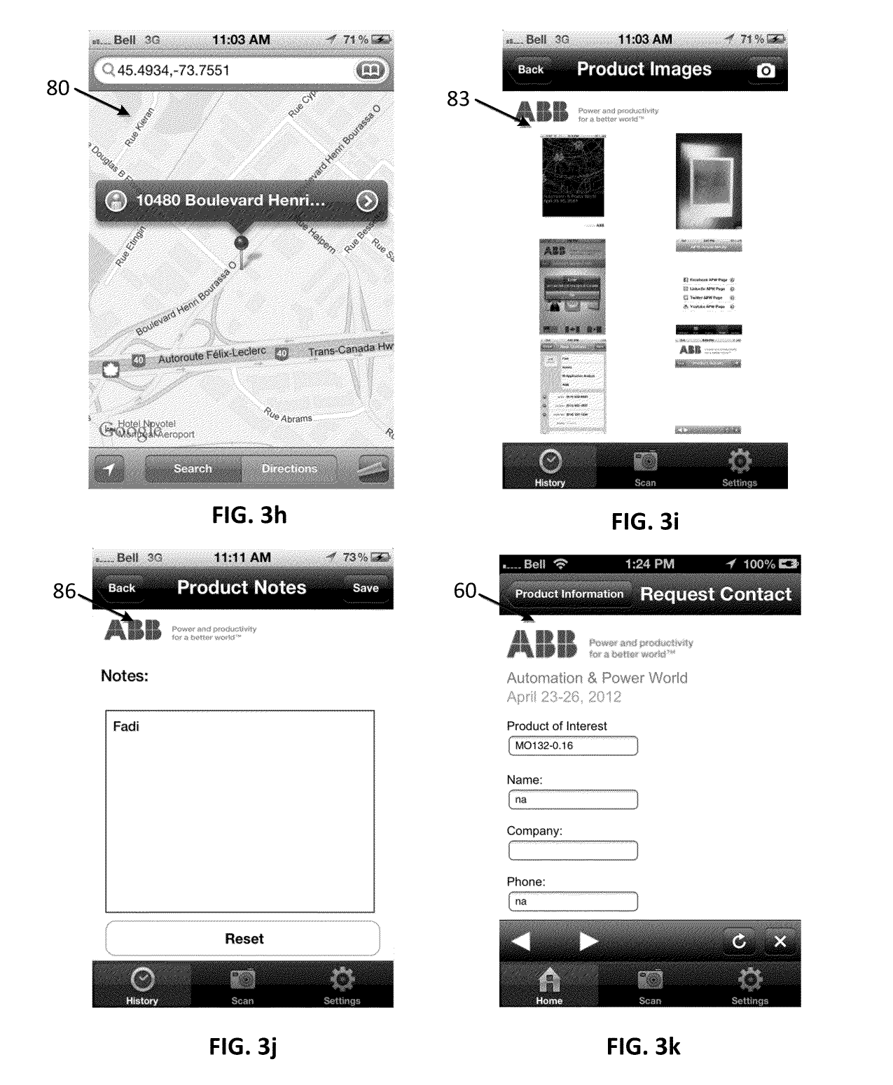

At step 40, and as shown in FIG. 3a, the user is presented with the options of selecting product details 40, contacting the service department 50, filling out a form to have a service professional contact the user 60, sharing product details via email or short message service (SMS) text message 70 or displaying the product location information 80.

With continued reference to FIG. 3a, screen 94 of the custom application is shown having the above mentioned options 40, 50, 60, 70, 80 in addition to a tool bar 85 that allows the user to scan/capture a bar code, review and manage history of scanned/captured objects, and change settings for the custom application. Within the settings, the user can set up a user profile and review and accept terms and conditions for using the custom application. The user may also provide feedback on the custom application to the organization supporting the custom application.

If the user chooses the product information option 40, information about the product such as specifications, technical manuals, service manuals, engineering drawings and other information regarding the object scanned are presented to the user and available for download to the user's device 480 at step 42. The product details option 40 accesses a product information system (PIS) 450, having a hierarchical structure, to route the object's product identification code to sites containing more information about the product.

With reference to FIGS. 1a, 1b, and 3a, upon selection of the product information option 40, the selection options available to the user are shown in FIG. 3b. The selection options within the product information 40 menu include but are not limited to product details 41, product documents 43, product location 80, product images 83, and product notes 86. Upon selection of product details 41, the mobile version of PIS 450 is launched on the requesting the device and details such as product specifications are displayed as shown in the exemplary screen of FIG. 3f.

With continued reference to FIG. 1b, upon selection of the product documents option 43, the mobile version of the product library page is launched and manuals, CAD drawings, data sheets, and circuit diagrams are presented for the products as depicted in FIG. 3g.

Referring additionally to FIG. 3h, upon selection of the product location option 80, a map depicting the location of the desired product is shown in the computer application. The map also shows the user's location and driving directions between the location of the desired product and the user's location may be obtained from the map.

Referring now to FIG. 3i, upon selection of the product images option 83, an image library for capturing or viewing photos of the desired product 84 is presented. A user may upload, store, and view images of the desired product via the product images page 84.

With reference to FIG. 3j, upon selection of the product notes option 86, a user may enter text and save text associated with the product of interest. The text entered is retrievable by the user via the product scan. The text and images stored along with the product scan time and date are uploadable to a data repository in an ERP system or on the cloud.

With reference to FIG. 3k, if the option request contact 60 is selected in association with a product scan, a form is presented on the device 480 with pre-populated data from the product scan. The user may enter or change data in any of the fields prior to submitting the form to the customer service department of the organization supplying or servicing the product.

If the user selects the contact customer service option at step 50, the global positioning system (GPS) coordinates of the user's device 480 are determined. In one embodiment, the device 480 is a smart phone, tablet personal computer, or another type of personal computer and the GPS coordinates are determined by a custom application running on the user's smart phone, by way of non-limiting example. If the user enables GPS tracking in the custom application or in the smart phone settings, the GPS location is tracked by the device 480 and also by the custom application.

The GPS coordinates and scanned product information including product ID, product name, product serial number, lot number and manufacturing are saved in the mobile smart phone application history and uploaded to the cloud 400 where the data is stored in a cloud 400 data repository. The data may be indexed for querying and reporting, and is generally made accessible to web portals, business integration portals and various forms of data storage existing on the cloud 400.

The contact customer service option at step 50 takes the user to a second screen 96 as depicted in FIG. 3c and the user is presented with options to send an e-mail 90 as shown in FIG. 3d, an SMS text message 74 as shown in FIG. 3e, or call services 64. If GPS location tracking is enabled on the device 480 that initiates the request, the GPS coordinates are used to determine the city, state, and/or country where the product was scanned. The application routes the requests to the specific customer service department for the determined location. The custom application pre-populates the corresponding customer service phone number into the device and a phone call is initiated by the custom application when selection option 64 is chosen.

After the selection by the user of the e-mail 90 function, for example, the user's device 480 links to a list of e-mail providers and an e-mail address is automatically populated into the recipient field of the application generated e-mail. Likewise, the phone number or SMS text address of the recipient service department in the country in which the request was initiated is populated in the corresponding recipient field or phone dialer.

Referring now to FIG. 3a, the countries are represented as the flags 99 of the United States, Canada, and Mexico, by way of non-limiting example. The user has the option to select one of the flags 99 as shown in FIG. 3a, which represent the various countries that are supported. This selection will take the user to a set of options for the country selected and pre-populate the recipient support center's e-mail address, text message address, or phone number in the appropriate function of the device 480.

The e-mail 92 and SMS text messages 76 that the user may opt to generate via the mobile application following a capture of a barcode, contain decoded information from the captured barcode. The decoded information includes the product ID, serial number, lot number, manufacturing location, GPS coordinates of the scanned object's location and a link for detailed product information as depicted in FIG. 3b. The e-mail 92 or text message 76 having the decoded information is sent to the service department for the area determined by the GPS coordinates and application mapping from GPS coordinates to service office location, as described above.

An example of the decoded information is shown in the screen shot 65 of FIG. 3b having a product information link 67 and a current user location link 79. Alternatively, if the user opts to call the service department at step 64, the call 66 will be placed to the service department mapped to the GPS coordinates of the user's device 480.

If the user opts not to contact the service department and selects the contact me option at step 60, the user is taken to an online form to provide information regarding the product and the user's contact details. The form has drop-down lists for categorizing the product and the market segment of the customer. The information is submitted via e-mail to the customer service department based on selections made by the user in the form.

If the user opts to share the product information and GPS coordinates of the scanning device 480, at step 70, an e-mail can be sent to any recipient with the product, serial number, lot number, manufacturing location, GPS coordinates of the scanned object's location and a link to product information. Alternatively, at step 80, the user may choose to view the current location of the device 480 on a map as well as the manufacturing location of the scanned product. The device's current location or the manufacturing location for the product is indicated by a marker on a map of the surrounding area.

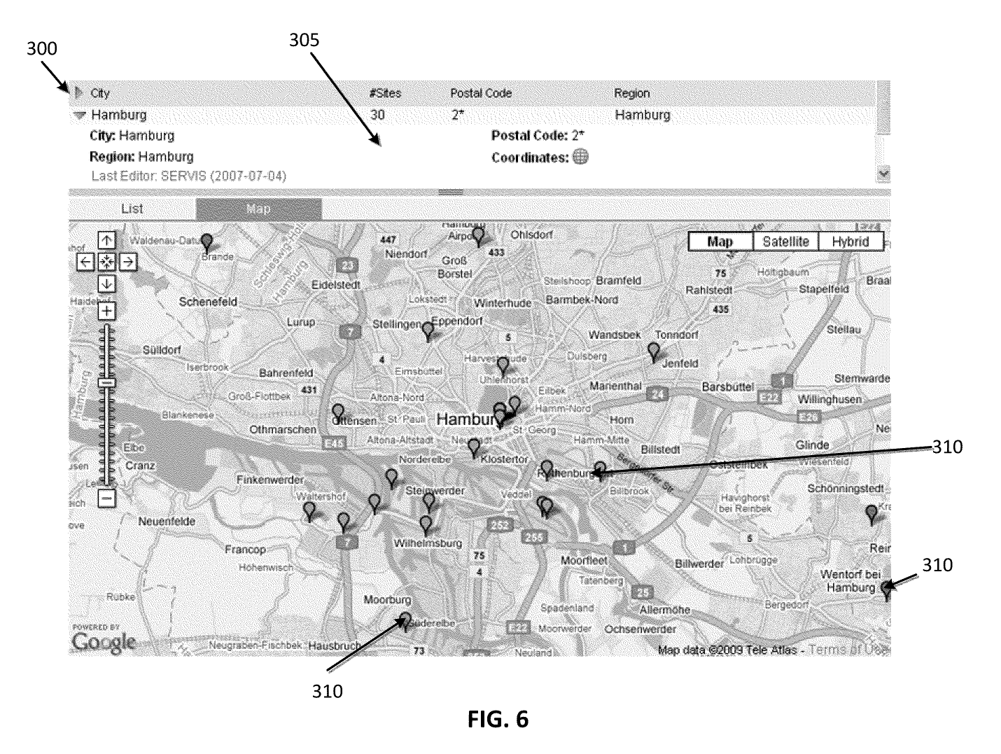

At step 80, if the user chooses to view the location of the product, a map will open up in the browser and a push-pin or marker 310 locates that product on the map as depicted in FIG. 6.

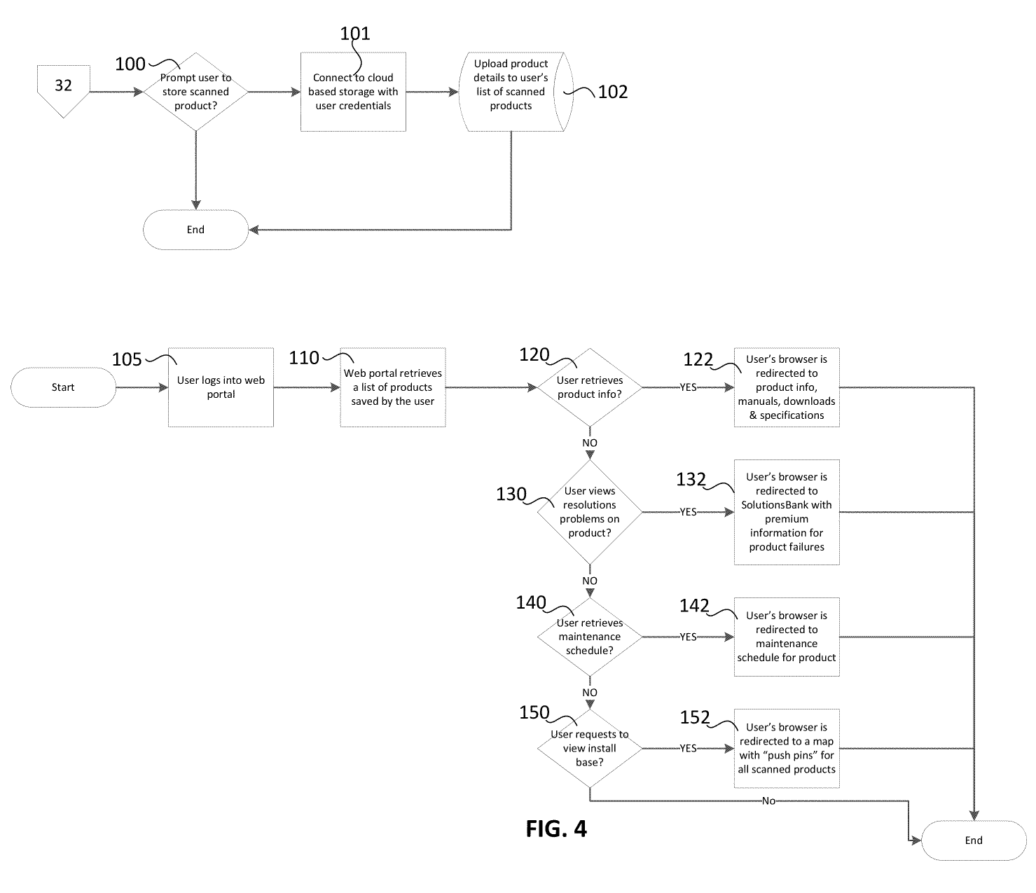

Referring now to FIG. 4, a process flow for the pro tier application 32 is shown. The pro tier application 32 is a service that stores information about the products scanned by the custom application. At step 101, the user authenticates and connects to the cloud to store the scanned information from the history of the custom mobile application. Further, at step 102, data associated with the scanned products including data and time stamp of scan, product ID, product name, manufacturing location, and GPS coordinates of the bar code scanning device 480 among other information, are stored in a data repository on the cloud 400.

At step 105, the user logs in and authenticates to the web portal to retrieve a list of product scans saved by that user or other users that the authenticated user has permission to view at step 110. At step 120, if the user decides to retrieve product information, the user's browser is directed to product details, specifications, and downloads including engineering drawings and manuals.

If the user at step 130 decides to view problem resolutions for the product, the user's browser is directed to the organization's solution management 460 system to address product issues and questions at step 132. The solution management 460 system allows the user to access technical information, share questions and answers on a forum, or enter a live chat with an organization's support personnel.

If the user at step 140 opts to retrieve a maintenance schedule for the object, the user's browser is redirected to the maintenance schedule 142. The maintenance schedule has detailed information for each pre-defined milestone of the product's lifecycle. Once maintenance is performed for a milestone, the maintenance schedule tracks the time and data stamp of the performed maintenance. The user may also add new maintenance milestones to the maintenance schedule at step 142.

If the user at step 150 requests to view the installed base of the organization's products on a map, the user's browser is redirected to a map similar to the map shown in FIG. 6. The map, at step 152, has push pins to represent the locations of the scanned products on the map. The push pins represent products and units delivered by the organization to the customer and in service at a customer site.

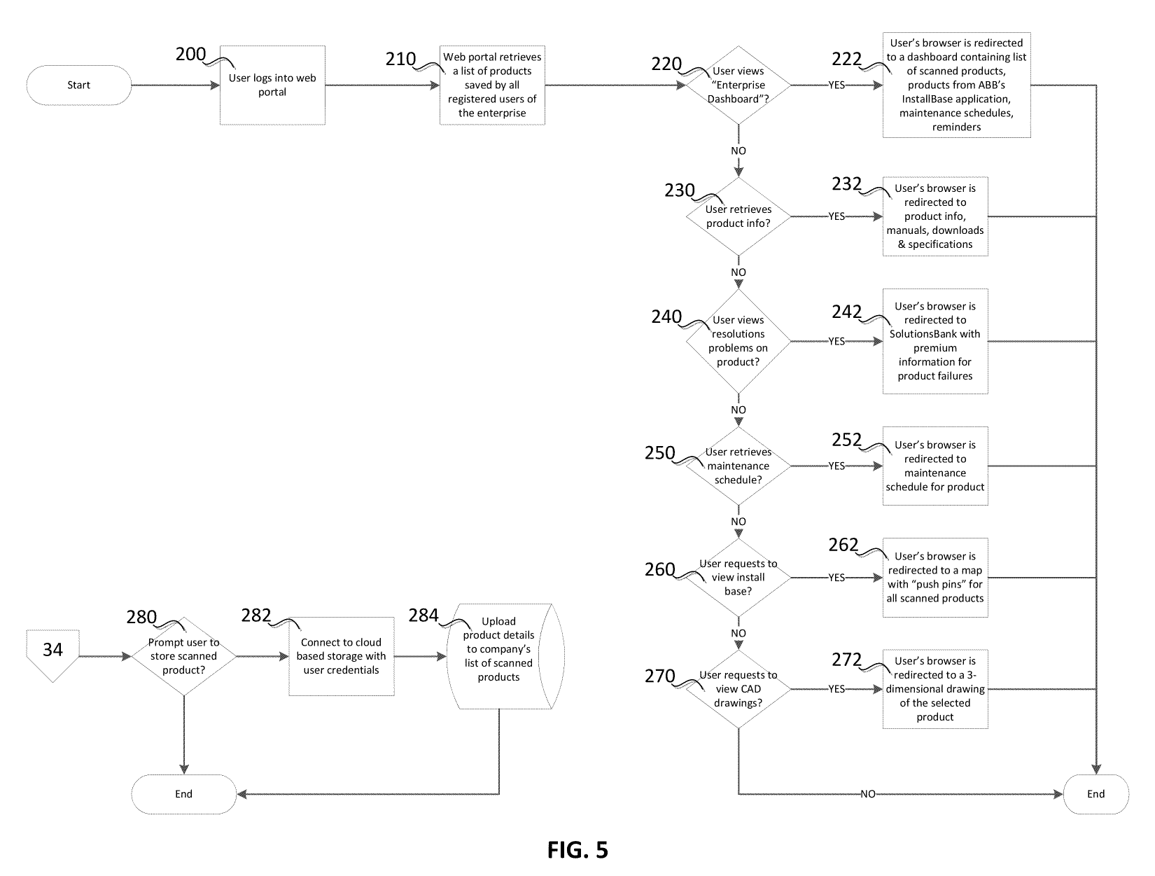

Referring now to FIG. 5, an Enterprise tier 34 is shown. The data of the Enterprise tier 34 is populated at step 280 if the user responds affirmatively to a request to store the products and information about the products that the user has scanned. At step 282, the user logs onto the cloud storage site. At step 284, the user uploads product details to the organizations list of scanned products.

At step 200 of FIG. 3, an employee from the user's organization logs into a portal to access the enterprise tier 34. The web portal retrieves a list of products saved by all registered users at step 210. The user may then view the Enterprise Dashboard at step 220. The Enterprise Dashboard depicts a list of scanned products by customer ID or user, products from the supplying organization's installed base map and application, maintenance schedules, and maintenance reminders.

If at step 230, the user opts to retrieve product information, the user's browser is redirect to product information, manuals, downloads, and specifications 232. If at step 240, the user decides to view resolutions to problems and FAQs, the user's browser is redirected to the solutions management system 460 having premium information for product issues at step 242. If at step 250, the user decides to view the maintenance schedule, the user is redirected to a maintenance schedule for the product at step 252. If the user decides at step 260, to view the installed base, the user is redirected to a map similar to FIG. 6, having push-pins to depict the scanned products at step 262. Alternatively, if the user chooses to view CAD drawings, the user's browser is directed to a 3D drawing of the selected product.

The user also has the option to navigate to the organization's social media sites, a chat room with the feature of live chat with a service professional from the organization, a forum for posting questions and answers about a product or service which is monitored by the organization, or post links from the organization's social media into a user's own social media page or profile.

In the event the user requires information regarding a new product or a special implementation of the product or service, an option is provided on the custom application to request contact by a salesperson. The user completes and submits a form. The request is routed to a salesperson having expertise in a particular area based on drop down information identifying the user's market segment and specific product inquiry entered in the form. The salesperson receives the request via e-mail or SMS text message.

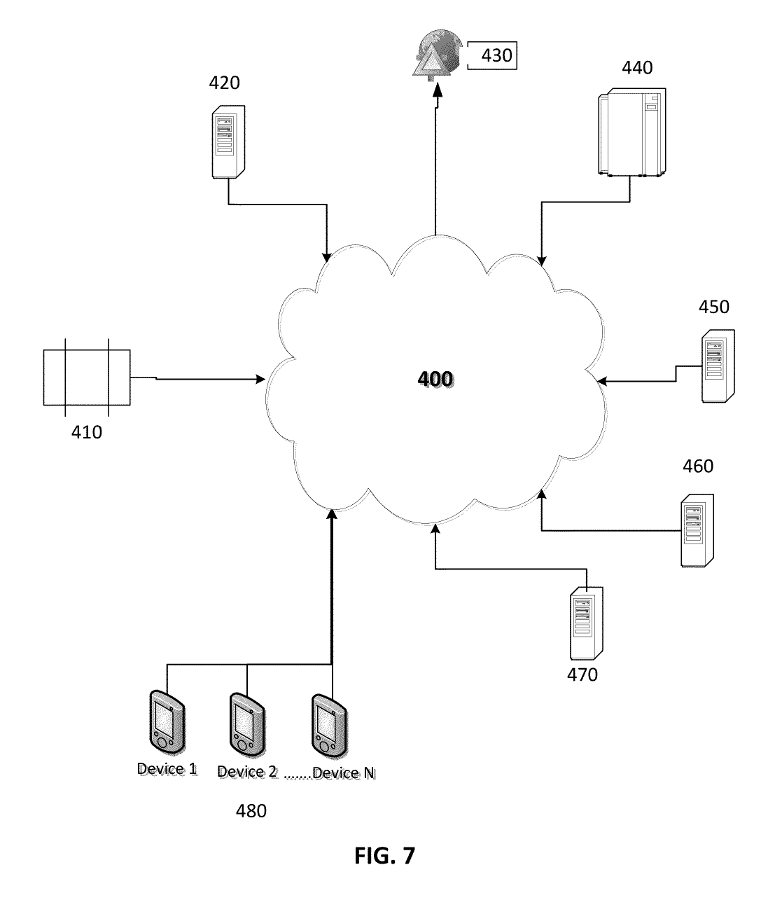

Referring now to FIG. 7, a high level view of exemplary applications, systems, devices, and equipment 410, 420, 440, 450, 460, 470, 480 that provide data to one or more data repositories stored on a cloud 400 is shown.

Installed equipment 410 provides the one or more data repositories on the cloud 400 with data such as decoded information from scanned bar codes present on the installed equipment 410. The data is transferred to a data structure on the cloud data repository. The data can be queried, compared, and appended to other data structures stored and indexed on the cloud 400 data repository.

Examples of installed equipment 410 having data stored in the cloud 400 data repository are smart grid products such as circuit breakers, transformers, and smart meters. The installed equipment 410 is configured to transmit data to the cloud 400 data repository by an initiating bar code scan of the installed equipment 410. The data is utilized to determine peak energy usage, energy consumption during certain time periods, real-time energy consumption of household or commercial sites and for the prevention and resolution of faults.

In one embodiment, products such as pad-mounted transformers are used in smart grid applications to step-down and supply power to residential or commercial locations. The initiation of energy demand profile tracking of the locations powered by a specific transformer occurs by scanning a bar code on the transformer and a bar code on a smart meter installed in each residence or commercial building. The GPS coordinates of the transformer and smart meter, time stamp, current readings, voltage readings and kilowatt hour power consumption by the various residences or buildings as well as other information may be tracked. This data may be transferred to the installed base system 420 and the cloud 400 for reporting and monitoring via a portal 430.

Another example of installed equipment 410 that may be utilized in smart grid applications are instrument transformers that measure current and voltage in addition to smart meters may be scanned and entered into the installed base system 420. The data generated by the instrument transformers such as timestamp, GPS coordinates of the scanned equipment bar codes, voltage, and current readings is stored in a data structure of the installed base program. Additionally, the data is stored in a data repository on the cloud 400.

An installed base system 420 also feeds data to the data repository on the cloud 400. The installed base system 420 manages installed equipment using characteristics of that equipment and installation location further honed by the GPS coordinates of bar code scanned equipment. The installed base system 420 is a cockpit that allows a user to manage all installed equipment from the organization. The installed base system 420 is able to apply a maintenance requirement to equipment and detect other equipment having the same or similar characteristics and apply the maintenance requirement to that equipment. In this way, the installed base system 420 prevents product failures by early detection.

Further, an Enterprise Resource Planning (ERP) system 440 stores data in the data repository on the cloud 400. The data stored by the ERP system 440 on the cloud 400 includes service contracts and other data associated with the scanned bar codes of installed products 410. The user can access a portal 430 that links the user to the pro tier application 32 and view the service contracts associated with the scanned objects or products. The user can renew the service contracts through the portal 430. Additionally, the user can check inventory for products as well as order products and services through the portal 430 using the data from the ERP system 440.

Alternatively, the user may access the organization's ERP system 440 through an interface, such as a custom order entry interface, that communicates with the portal 430. After authentication, the user may check inventory, order product, and renew service contracts through the portal 430 and the interface.

The PIS 450 provides product data to the cloud 400. The hierarchical structure of the PIS is used to map the scanned product ID to detailed information about the product such as product specifications and service information.

Information from a solution management application 460 is stored on the cloud 400. The solution management application 460 provides technical bulletins, product manuals, engineering change documents and product and service documentation. The solution management system 460 monitors customer-specific product and system installations and sends e-mail notifications regarding technical and product release information. Additionally, downloads of service packs, release notes and updates are available through the solution management application 460 as well as a video library providing information on software installation, operation, configuration and diagnostics. The solution management system 460 also tracks support tickets and cases logged by customers.

Information from a knowledge management application 470 is stored on the cloud 400. The knowledge management application 470 allows organization support personnel to capture product knowledge and expertise in a database. Knowledge articles are created, approved, and published by support personnel using the knowledge management application 470. Support cases and tickets may be transformed into useful articles for troubleshooting particular problems.

The devices 480 used to scan bar codes on the installed equipment or other objects may connect directly to the cloud to upload data for storage in the cloud 400 data repository.

A portal 430 or another website allows a user to access data from the applications, systems, devices, and equipment 410, 420, 440, 450, 460, 470, 480 that store data on the cloud. The data accessible to the user includes a log of all scanned bar codes, the decoded information from the bar codes, date and time stamp of bar code capture, GPS coordinates of the device 480 initiating the scan, information about the object being scanned, URLs and various other information. The data is stored in a data structure of a data repository in a data center or in the cloud for use in reporting, monitoring, or otherwise providing service to users.

A method for utilizing the energy demand profile for a product bearing a bar code that is uploaded to the data repository is contemplated by the present application. The user-generated history of bar code scans of products is stored in the data repository of a cloud service along with energy usage, consumption, or demand by the scanned products. The coordinates of the products of interest are stored and saved in the data repository so that a report can be generated from the product scans and energy demand data in a portal or similar application. Consumers of electricity may be billed based on the energy consumption data. Utility companies may use this data for trending and predicting future demand as well as responding to predictions of increased demand by installing additional equipment.

The data from the applications, systems, devices, and equipment 410, 420, 440, 450, 460, 470, 480 may be stored on the cloud 400 as sets of data in online analytical processing (OLAP) cubes, in relational databases, or other custom database configurations for access by a business integration or data warehousing system for reporting, data mining, process monitoring and control purposes. The user may access business integration system data via the portal 430.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

1. A system, comprising:
a memory that stores computer executable instructions; and
a processor that executes the computer executable instructions, wherein executing the computer executable instructions causes the processor to implement:
a determination of a requesting user's global positioning system coordinates;
a mapping of said coordinates to a set of service communication options;
a presentation of said service communication options based on said mapped coordinates;
transmission of a selected service communication to a service department, said transmission automatically populated with product information; and
initiation of said service request by said service system.

2. A computer readable storage medium encoded with one or more computer executable instructions, which, when executed by a processor of a computing system, causes the processor to:
determine a requesting user's global positioning system coordinates;
evaluate said coordinates based on predetermined evaluation criteria;
map said coordinates to service options for user's determined location;
present service communication options based on said mapping;
transmit the selected service communication option to a service department; and
receive a response from said service department regarding the initiation of a service request.

3. A method for utilization of user generated history for reporting, comprising:
receiving from a mobile device, in a computer-based service request system, a bar code scan associated with a product and a history of energy usage for said product bar code being scanned;
storing said product bar code scan and energy usage data in a data repository on a cloud service;
determining coordinates of said product being scanned;
saving said coordinates in said data repository on said cloud service; and
generating a report from data stored in said data repository; and
presenting said report in a web portal.

4. The method of claim 4 wherein said data of said report is used by a utility company to bill customers.

5. The method of claim 1 wherein the product information further comprises a product number and a serial number.

6. The method of claim 5 wherein the product information further comprises a lot number corresponding to the product.
